(19) United States
(12) Patent Application Publication
(10) Pub. No.: US 2010/0208451 A1
(43) Pub. Date: Aug. 19, 2010

(54) BACKLIGHT MODULE AND METHOD OF ARRANGEMENT OF LAMPS

(76) Inventors: Sheng-Chieh Chao, Taoyuan County (TW); Hung-Yi Ou Yang, Taipei County (TW); Wen-Yu Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/405,219

(22) Filed: Mar. 16, 2009

(30) Foreign Application Priority Data
Feb. 18, 2009 (TW) 098105088

(51) Int. Cl. G02F 1/13357; H01J 9/24

(52) U.S. Cl. 362/97.1; 445/23

(57) ABSTRACT

A backlight module includes a housing and a plurality of U-type lamps and a plurality of straight-type lamps. The U-type lamps and the straight-type lamps are arranged in an alternate way so that the pitches between the U-type lamps and the straight-type lamps may be various to provide a variation of brightness of the backlight module.

### BACKGROUND OF THE INVENTION

1. Field of the Invention

The present invention relates to a backlight module and a method of arrangement of lamps, and more particularly, to a backlight module including U-type lamps and straight-type lamps at the same time and a method of arrangement of lamps.

2. Description of the Prior Art

Conventionally, a liquid crystal display (LCD) device includes a backlight module for providing a backlight source to an LCD panel. The cold cathode fluorescent lamps (CCFLs) have become widely popular and dominate the market of LCD devices due to the advantages of low price and mature technology, especially the market of medium-scale or large-scale LCD panels. In order to achieve the goal to reduce costs, some backlight module suppliers have adopted U-type CCFLs as backlight sources until now. With reference to FIG. 1, FIG. 1 is a schematic diagram illustrating a general U-type CCFL 10 may be applied to a conventional backlight module. Since the two parallel parts 12 of every conventional U-type CCFL 10 have a fixed pitch P therebetween, the arrangement of the U-type CCFLs 10 of the backlight module is limited to a minimum distance of the pitches. Consequently, the illumination density provided by the CCFLs 10 is also limited, too. It is therefore that although a lamp pitch between any two adjacent U-type CCFLs 10 can be adjusted when the U-type CCFLs 10 are taking as the backlight sources of the backlight module, the pitch P between two parallel parts 12 of each of the U-type CCFLs 10 still can not be diminished. Accordingly, the pitch between two parallel parts 12 serving as backlight sources of the U-type CCFLs 10 is just able to be larger than or equal to the pitch P.

Since current medium-scale and large-scale LCD panels are expected to be designed with higher brightness on the central region and with a goal to reduce cost or avoid additional cost, the objective of the conventional design is to increase the density of the arrangement of lamps near the central point of the display area of the LCD panel. However, as mentioned above, the lamp pitch can not be diminished or smaller than the pitch P due to the originally fixed pitch P between two parallel parts of the U-type CCFLs 10. Thus, the increase of the illumination density near the central point of the display area is accordingly limited. On the other hand, only the U-type CCFLs 10 with the same pitches P can be used in a single conventional backlight module. Otherwise, the problems of lower illumination efficiency of lamps and a poor quality control will occur easily. The U-type CCFLs 10 with different values P of the pitches can not be applied to a single backlight module at the same time for changing the luminance or brightness of different regions of the backlight module. In brief, the design of the conventional backlight module adopting U-type CCFLs 10 can not meet the demand of raising the brightness near the central point of the display area nowadays.

### SUMMARY OF THE INVENTION

One object of the present invention is to provide a backlight module including U-type CCFLs and straight-type lamps arranged alternately thereon at the same time and a method of arrangement of lamps of the backlight module.

The present invention discloses a backlight module including a housing having a bottom plane, a plurality of U-type lamps and a plurality of straight-type lamps. The straight-type lamps and the U-type lamps are arranged in parallel with each other on the bottom plane of the housing.

The present invention further discloses a method of arrangement of lamps. Firstly, a bottom plane is provided. Then, a plurality of U-type lamps and a plurality of straight lamps are provided on the bottom plane, and any two adjacent lamps of the U-type lamps or the straight lamps have a lamp pitch. According to the present design, the lamp pitches are incompletely the same.

According to the present invention, since a plurality of U-type lamps and a plurality of straight lamps are alternately arranged in a parallel with each other on the bottom plane of the housing of the backlight module at the same time, the illumination density of the backlight sources can be changed by adjusting the lamp pitch between any two adjacent lamps of the straight-type and U-type lamps so as to achieve the objective to increase the brightness of the central region of the backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a general U-type CCFL.

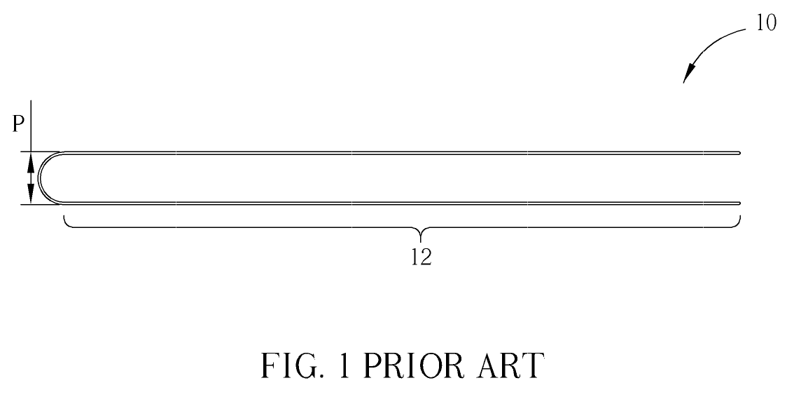

FIG. 2 is a schematic diagram showing a first embodiment according to the backlight module of the present invention.

FIG. 3 is a schematic diagram showing a second embodiment according to the backlight module of the present invention.

FIG. 4 is a schematic diagram showing a third embodiment according to the backlight module of the present invention.

### DETAILED DESCRIPTION

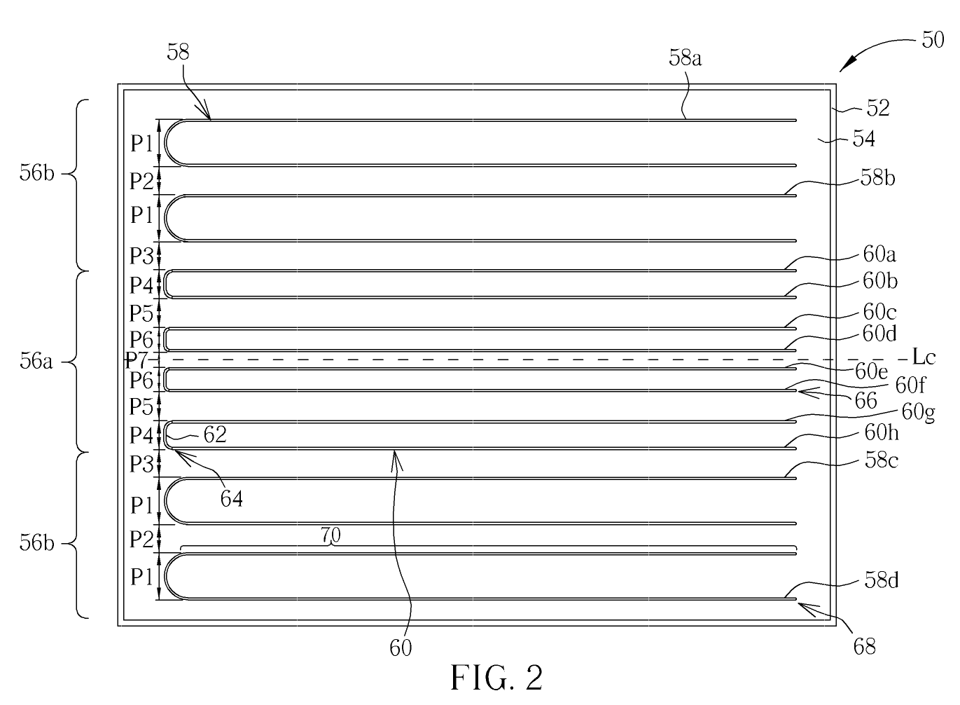

With reference to FIG. 2, FIG. 2 is a top view diagram showing a first embodiment according to the backlight module of the present invention. The backlight module 50 of the present invention is a direct-type backlight module for use as a backlight source in an LCD device. The backlight module 50 of the present invention includes a housing 52 having a bottom plane 54 for disposing light sources. The backlight module 50 includes a plurality of U-type lamps 58 and a plurality of straight-type lamps 60. The U-type lamps 58 and the straight-type lamps 60 can be CCFLs in a parallel arrangement on the bottom plane 54 of the housing 52. In the present embodiment, the bottom plane 54 can be divided into a central region 56a and a peripheral region 56b disposed on upper and lower sides of the central region 56a.

Each of the U-type lamps 58 includes two parallel parts 70 and has a fixed first pitch P1. Thus, in order to increase the brightness of the central region 56a of the bottom plane 54, the straight-type lamps 60 are centralized to be disposed in the central region 56a in order to adjust the lamp pitches between any two adjacent straight-type lamps 60 (such as reducing each of the lamp pitches between any two adjacent straight-type lamps 60) so as to increase the illumination density of the central region 56a. On the other hand, the U-type lamps 58 with the fixed first pitches P1 are disposed on the peripheral region 56b of the bottom plane 54. As shown in FIG. 2, a first straight-type lamp 60a, a second straight-type lamp 60b, a third straight-type lamp 60c, a fourth straight-type lamp 60d, a fifth straight-type lamp 60e, a sixth straight-type lamp 60f, a seventh straight-type lamp 60g, and an eighth straight-type lamp 60h are disposed in the central region 56a of the bottom plane 56a in order. The U-type lamps 58 are disposed in the peripheral region 56b such as the first and second U-type lamps 58a, 58b disposed on the top side and the third and fourth U-type lamps 58c, 58d disposed on the bottom side of FIG. 2.

In the present embodiment, a central line Lc parallel to a direction of both the U-type lamps 58 and the straight-type lamps 60 is disposed on the bottom plane 54. The central line Lc divides the bottom plane 54 into the top side and the bottom side with the same areas, while the U-type lamps 58 and straight-type lamps 60 respectively disposed on the top and bottom sides of central line Lc are in a symmetrical arrangement symmetrical to the central line Lc. As shown in FIG. 2, a second lamp pitch P2 between the first U-type lamp 58a and the second U-type lamp 58b is identical to the second lamp pitch P2 between the third U-type lamp 58c and the fourth U-type lamp 58d; a third lamp pitch P3 between the second U-type lamp 58b and the first straight-type lamp 60a is identical to the third lamp pitch P3 between the third U-type lamp 58c and the eighth straight-type lamp 60h; a fourth lamp pitch P4 between the first straight-type lamp 60a and the second straight-type lamp 60b is identical to the fourth lamp pitch P4 between the eighth straight-type lamp 60h and the seventh straight-type lamp 60g; a fifth lamp pitch P5 between the second straight-type lamp 60b and the third straight-type lamp 60c is identical to the fifth lamp pitch P5 between the sixth straight-type lamp 60f and the seventh straight-type lamp 60g; and a sixth lamp pitch P6 between the third straight-type lamp 60c and the fourth straight-type lamp 60d is identical to the sixth lamp pitch P6 between the fifth straight-type lamp 60e and the sixth straight-type lamp 60f. A seventh lamp pitch P7 is between the fourth straight-type lamp 60d and the fifth straight-type lamp 60e, and the central line Lc is disposed in the seventh pitch P7. According to above-mentioned description, in order to increase the brightness of the central region 56a of the backlight module 50, the lamp pitches between any two adjacent lamps of the U-type lamps 58 or straight-type lamps 60 near the central line Lc should be smaller than or equal to those between any two adjacent lamps of the U-type lamps 58 or straight-type lamps 60 away from the central line Lc. It is therefore that a relationship formula of each value of the pitches can be represented as follows:

P1≧P2≧P3≧P4≧P5≧P6≧P7

Thus, the lamp pitches between any two adjacent lamps of the U-type lamps 58 or straight-type lamps 60 disposed on either side of the central line Lc on the bottom plane 54 are unequal to each other, and the lamp pitch (such as the fourth lamp pitch P4 or the fifth lamp pitch P5) between any two adjacent straight-type lamps 60 is smaller than or equal to the first pitch P1 between the two parallel parts 70 of each of the U-type lamps 58. However, the width of each of the lamp pitches such as P2 to P7 is not limited to the aforementioned relationship formula. According to the arrangement of the U-type lamps 58 and the straight-type lamps 60, there are seven kinds of lamp pitches (such as P1 to P7) can be used for design.

It should be noted that the high-voltage ends 68 of the U-type lamps 58 and the high-voltage ends 66 of the straight-type lamps 60 are all disposed on the right side of the backlight module 50, and the low-voltage ends 64 of the straight-type lamps 60 are disposed on the left side of the backlight module 50. Moreover, in the present embodiment, the backlight module 50 further includes four lead wires 62 respectively connecting two adjacent straight-type lamps 60 in series. For example, the low-voltage ends 64 of both the first straight-type lamp 60a and the second straight-type lamp 60b are connected in series via the lead wire 62 so as to make two adjacent straight-type lamps 60 have an illumination effect similar to each of the U-type lamps 58. However, in other embodiments, the lead wires 62 can be replaced by an electrical connection structure such as a driver circuit board made of electrical conductive material for directly connecting the two low-voltage ends 64 of two adjacent straight-type lamps 60 in series.

As mentioned above, the present invention provides a method of arrangement of lamps of a backlight module. According to the present invention method, a plurality of U-type lamps and a plurality of straight-type lamps are arranged in a parallel with each other on the bottom plane of the housing, and the lamp pitch between any two adjacent lamps of the U-type lamps or straight-type lamps can be adjusted to make each of the lamp pitches be incompletely equal to each other. For instance, the lamp pitches between two adjacent lamps of the U-type lamps or straight-type lamps away from the central line on the bottom plane may be larger than those between two adjacent lamps of the U-type lamps or straight-type lamps near the central line so as to increase the illumination density and brightness in the central region of the bottom plane.

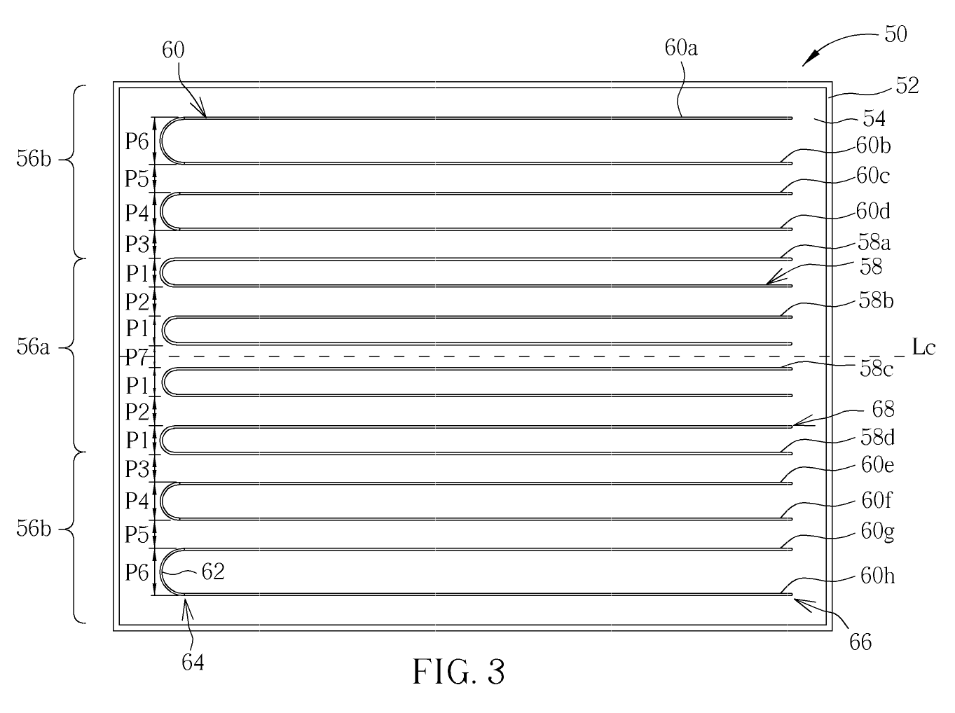

With reference to FIG. 3, FIG. 3 is a schematic diagram showing a second embodiment according to the backlight module of the present invention. In order to provide explanation with ease, the same numbered elements already used in FIG. 2 are still used in FIG. 3. In the present embodiment, the U-type lamps 58 are centralized to be disposed on the central region 56a of the bottom plane 54, and the straight-type lamps 60 are averagely disposed on the periphery region 56b of the bottom plane 54. Similarly, since the backlight module 50 includes both the U-type lamps 58 and the straight-type lamps 60 at the same time, the lamp pitches between any two adjacent straight-type lamps 60 can be freely adjusted, while the lamp pitch between a straight-type lamp 60 and a U-type lamp 58 can be freely adjusted, too. Accordingly, the demand of the desired brightness of the backlight module can be achieved. For instance, the U-type lamp 58 having a small first pitch P1 can be used and disposed in the central region 56a, and the lamp pitches of the straight-type lamps 58 in the periphery region 56b can be designed to have large value. Since two adjacent straight-type lamps 58 have a larger pitch therebetween and are disposed on the periphery region 56b, both the sixth lamp pitch P6 and the fifth lamp pitch P5 are larger than the first pitch P1 so as to increase the brightness of the central region 56a of the backlight module 50. However, if a higher illumination density of the periphery region 56b of the backlight module 50 is needed according to a special design, the sixth lamp pitch P6 and the fifth lamp pitch P5 can be oppositely reduced.

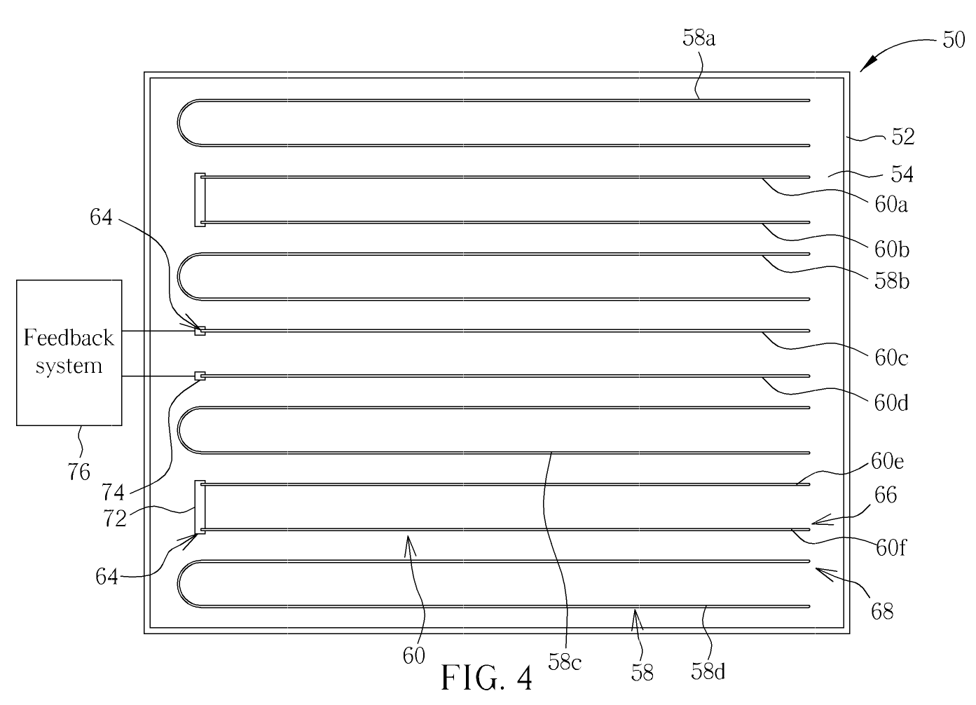

With reference to FIG. 4, FIG. 4 is a schematic diagram showing a third embodiment according to the backlight module of the present invention. Wherein, the same numbered elements already used in FIG. 2 are still used in FIG. 4. In the present embodiment, four U-type lamps 58 and six straight-type lamps 60 are used herein. The first U-type lamp 58a, the first straight-type lamp 60a, the second straight-type lamp 60b, the second U-type lamp 58b, the third straight-type lamp 60c, the fourth straight-type lamp 60d, the third U-type lamp 58c, the fifth straight-type lamp 60e, the sixth straight -type lamp 60f, and the fourth U-type lamp 58d are arranged in order from the top side to the bottom side of FIG. 4. Accordingly, the straight-type lamps 60 are divided into several groups, and each group having two straight-type lamps 60 is disposed between two adjacent U-type lamps 58. By virtue of alternate arrangement of the groups having two straight-type lamps 60 and the U-type lamp 58 in turn, the lamp pitches between the straight-type lamp 60 and the U-type lamp 58 can be adjusted at random so as to adjust the brightness of each region of the backlight module 50. However, in other embodiments, only a single straight-type lamp 60 may also be disposed just between two adjacent U-type lamps 58. It is therefore that the straight-type lamps 60 and the U-type lamps 58 are arranged alternately on the bottom plane 54. The illumination density can be changed by adjusting the lamp pitch between a straight-type lamp 60 and a U-type lamp 58 adjacent to each other.

It should be noted that the lead wire 62 in the first and second embodiments of the present invention is replaced by an electrical connection structure, such as a driver circuit board 72 for connecting the low-voltage ends 64 of the first and second straight-type lamps 60a, 60b in series and the low-voltage ends 64 of the fifth and sixth straight-type lamps 60e, 60f in series, so as to respectively form two light source groups similar to the U-type lamps. Moreover, the low-voltage ends 64 of the third and fourth straight-type lamps 60c, 60d are respectively electrically connected to a driver circuit board 74 such as a printing circuit board (PCB). The driver circuit board 74 can be further electrically connected to a feedback system 76. By virtue of the internal setup mode in the backlight module 50 or the display device for use, the feedback system 76 can dynamic control the brightness efficiency of the third and the fourth straight-type lamps 60c, 60d so as to adjust the brightness of the third and fourth straight-type lamps 60c, 60d according to dynamic needs.

Compared with the conventional art, since the backlight module of the present invention includes a plurality of U-type lamps and a plurality of straight-type lamps at the same time, the backlight module is not similar to the conventional backlight module only with U-type lamps disposed thereon. The illumination of the conventional backlight module is limited to the fixed pitch of the U-type lamps. In contrary, the backlight module of the present invention has advantages as follows. Firstly, the lamp pitch between any two adjacent lamps can be adjusted according to design requirement, especially when the straight-type lamps are centralized to be disposed in the central region of the backlight module. Consequently, the illumination density and brightness of the central region can be increased by reducing lamp pitches. Secondly, the present invention also illustrates that the low-voltage ends can be connected in series via an electrical connection structure such as a lead wire or a driver circuit board so as to make two straight-type lamps have a same illumination effect similar to the U-type lamps. Accordingly, the circuit design and layout of the present backlight module can be simplified and additionally applied to the conventional backlight module only with U-type lamps disposed thereon.

Those skilled in the art will readily observe that numerous modifications and alterations of the device and method may be made while retaining the teachings of the invention.

What is claimed is:

1. A backlight module, comprising:
a housing having a bottom plane; and
a plurality of U-type lamps and a plurality of straight-type lamps, and the U-type lamps and the straight-type lamps arranged parallel to each other on the bottom plane.

2. The backlight module of claim 1, wherein the straight-type lamps are disposed between the U-type lamps.

3. The backlight module of claim 1, wherein the U-type lamps are centralized to be disposed on a central region of the bottom plane, and the straight-type lamps are disposed on a periphery region of the bottom plane.

4. The backlight module of claim 1, wherein the straight-type lamps are centralized to be disposed on a central region of the bottom plane, and the U-type lamps are disposed on a periphery region of the bottom plane.

5. The backlight module of claim 4, wherein a pitch between any two adjacent straight-type lamps is smaller than or equal to a pitch between two parallel parts of each of the U-type lamps.

6. The backlight module of claim 1, wherein the bottom plane has a central line parallel to a direction of the straight-type lamps, and a pitch between two parallel parts of each of the U-type lamps or a pitch between any two adjacent straight-type lamps near the central line on the bottom plane is smaller than or equal to that between two parallel parts of each of the U-type lamps or that between any two adjacent straight-type lamps away from the central line on the bottom plane.

7. The backlight module of claim 1, wherein the bottom plane has a central line parallel to a direction of the straight-type lamps, and pitches between any adjacent U-type lamps or straight-type lamps on either side of the central line are unequal.

8. The backlight module of claim 1, wherein the backlight module further comprises at least an electrical connection structure that electrically connects two low-voltage ends of any two adjacent straight-type lamps in series, and high-voltage ends of the two straight-type lamps and high-voltage ends of the U-type lamps are disposed on the same side of the bottom plane.

9. The backlight module of claim 1, wherein the backlight module further comprises at least a driver circuit board electrically connected to a low-voltage end of one of the straight-type lamps.

10. The backlight module of claim 9, wherein the backlight module further comprises a feedback system electrically connected to the driver circuit board so as to control the illumination of the straight-type lamps.

11. The backlight module of claim 1, wherein the backlight module is a direct-type backlight module.

12. A method of arrangement of lamps, comprising:
providing a bottom plane;
providing a plurality of U-type lamps and a plurality of straight-type lamps disposed on the bottom plane, and any two adjacent U-type lamps or straight-type lamps having a lamp pitch; and
designing an arrangement of the U-type lamps and straight-type lamps to make all the lamp pitches not completely the same.

13. The method of claim 12, wherein the method further comprises a step of adjusting the arrangement of distances between the U-type lamps and the straight-type lamps to make the lamp pitches between any two adjacent lamps of the U-type lamps or straight-type lamps disposed in a central region of the bottom plane smaller than or equal to those between any two adjacent lamps of the U-type lamps or straight-type lamps disposed on a periphery region of the bottom plane.

14. The method of claim 12, further comprising:
defining a central line of the bottom plane, parallel to a direction of the straight-type lamps; and
making the lamp pitch between any two adjacent lamps of the U-type lamps or straight-type lamps away from the central line equal to or larger than that between any two adjacent lamps of the U-type lamps or straight-type lamps near the central line.

15. The method of claim 12, further comprising:
defining a central line on the bottom plane, parallel to a direction of the straight-type lamps; and
making the lamp pitches on either side of the central line be unequal to each other.

16. The method of claim 12, further comprising disposing each of the straight-type lamps between the U-type lamps.

17. The method of claim 12, further comprising centralizing the U-type lamps to be disposed in a central region of the bottom plane, and disposing the straight-type lamps in at least a periphery region of the bottom plane.

18. The method of claim 12, further comprising centralizing the straight-type lamps to be disposed in a central region of the bottom plane, and disposing the U-type lamps in at least a periphery region of the bottom plane.

19. The method of claim 18, wherein the parallel parts of each of the U-type lamps have a first pitch, and the method further comprises making the pitch between any two adjacent straight-type lamp smaller than or equal to the first pitch.

20. The method of claim 12, further comprising:
providing at least a wire connecting two low-voltage ends of two of the adjacent straight-type lamps in series; and
making high-voltage ends of the straight-type lamps and high-voltage ends of the U-type lamps be disposed on the same side of the bottom plane.
